(19) United States
(12) Patent Application Publication
(10) Pub. No.: US 2003/0012431 A1
(43) Pub. Date: Jan. 16, 2003

(54) Hybrid lossy and lossless compression method and apparatus

(76) Inventors: Ann C. Irvine, Bonsall, CA (US); Kadayam Thyagarajan, San Diego, CA (US)

Correspondence Address: QUALCOMM Incorporated, Attn: Patent Department, 5775 Morehouse Drive, San Diego, CA, 92121-1714, US

(21) Appl. No.: 10/193,813

(22) Filed: Jul. 11, 2002

Related U.S. Application Data
(60) Provisional application No. 60/305,457, filed on Jul. 13, 2001.

(51) Int. Cl. G06K 9/00

(52) U.S. Cl. 382/166

(57) ABSTRACT

A method of losslessly compressing and encoding signals representing image information is claimed. A lossy compressed data file is generated in a first color component space and a residual compressed data file is generated in a second color component space. When the lossy compressed data file and the residual compressed data file are combined, a lossless data file that is substantially identical to the original data file is created.

### CROSS-REFERENCE TO RELATED APPLICATION

This application claims priority to U.S. Provisional Application Serial No. 60/305,457, filed Jul. 13, 2001, pending, which application is incorporated herein by reference in its entirety.

### BACKGROUND OF THE INVENTION

I. Field of the Invention

The present invention relates to image processing and compression. More specifically, the invention relates to lossy and lossless encoding of video image information in the frequency domain.

II. Description of the Related Art

Digital picture processing has a prominent position in the general discipline of digital signal processing. The importance of human visual perception has encouraged tremendous interest and advances in the art and science of digital picture processing. In the field of transmission and reception of video signals, such as those used for projecting films or movies, various improvements are being made to image compression techniques. Many of the current and proposed video systems make use of digital encoding techniques. Aspects of this field include image coding, image restoration, and image feature selection. Image coding represents the attempts to transmit pictures of digital communication channels in an efficient manner, making use of as few bits as possible to minimize the band width required, while at the same time, maintaining distortions within certain limits. Image restoration represents efforts to recover the true image of the object. The coded image being transmitted over a communication channel may have been distorted by various factors. Source of degradation may have arisen originally in creating the image from the object. Feature selection refers to the selection of certain attributes of the picture. Such attributes may be required in the recognition, classification, and decision in a wider context.

Digital encoding of video, such as that in digital cinema, is an area that benefits from improved image compression techniques. Digital image compression may be generally classified into two categories: loss-less and lossy methods. A loss-less image is recovered without any loss of information. A lossy method involves an irrecoverable loss of some information, depending upon the compression ratio, the quality of the compression algorithm, and the implementation of the algorithm. Generally, lossy compression approaches are considered to obtain the compression ratios desired for a cost-effective digital cinema approach. To achieve digital cinema quality levels, the compression approach should provide a visually loss-less level of performance. As such, although there is a mathematical loss of information as a result of the compression process, the image distortion caused by this loss should be imperceptible to a viewer under normal viewing conditions.

Existing digital image compression technologies have been developed for other applications, namely for television systems. Such technologies have made design compromises appropriate for the intended application, but do not meet the quality requirements needed for cinema presentation.

Digital cinema compression technology should provide the visual quality that a moviegoer has previously experienced. Ideally, the visual quality of digital cinema should attempt to exceed that of a high-quality release print film. At the same time, the compression technique should have high coding efficiency to be practical. As defined herein, coding efficiency refers to the bit rate needed for the compressed image quality to meet a certain qualitative level. Moreover, the system and coding technique should have built-in flexibility to accommodate different formats and should be cost effective; that is, a small-sized and efficient decoder or encoder process.

Many compression techniques available offer significant levels of compression, but result in a degradation of the quality of the video signal. Typically, techniques for transferring compressed information require the compressed information to be transferred at a constant bit rate.

One compression technique capable of offering significant levels of compression while preserving the desired level of quality for video signals utilizes adaptively sized blocks and sub-blocks of encoded Discrete Cosine Transform (DCT) coefficient data. This technique will hereinafter be referred to as the Adaptive Block Size Discrete Cosine Transform (ABSDCT) method. This technique is disclosed in U.S. Pat. No. 5,021,891, entitled “Adaptive Block Size Image Compression Method And System,” assigned to the assignee of the present invention and incorporated herein by reference. DCT techniques are also disclosed in U.S. Pat. No. 5,107,345, entitled “Adaptive Block Size Image Compression Method And System,” assigned to the assignee of the present invention and incorporated herein by reference. Further, the use of the ABSDCT technique in combination with a Differential Quadtree Transform technique is discussed in U.S. Pat. No. 5,452,104, entitled “Adaptive Block Size Image Compression Method And System,” also assigned to the assignee of the present invention and incorporated herein by reference. The systems disclosed in these patents utilize what is referred to as “intra-frame” encoding, where each frame of image data is encoded without regard to the content of any other frame. Using the ABSDCT technique, the achievable data rate may be reduced from around 1.5 billion bits per second to approximately 50 million bits per second without discernible degradation of the image quality.

The ABSDCT technique may be used to compress either a black and white or a color image or signal representing the image. The color input signal may be in a YIQ format, with Y being the luminance, or brightness, sample, and I and Q being the chrominance, or color, samples for each 4:4:4 or alternate format. Other known formats such as the YUV, YC_{b}Cᵣ or RGB formats may also be used. Because of the low spatial sensitivity of the eye to color, most research has shown that a sub-sample of the color components by a factor of four in the horizontal and vertical directions is reasonable. Accordingly, a video signal may be represented by four luminance samples and two chrominance samples.

Using ABSDCT, a video signal will generally be segmented into blocks of pixels for processing. For each block, the luminance and chrominance components are passed to a block size assignment element, or a block interleaver. For example, a 16×16 (pixel) block may be presented to the block interleaver, which orders or organizes the image samples within each 16×16 block to produce blocks and composite sub-blocks of data for discrete cosine transform (DCT) analysis. The DCT operator is one method of converting a time and spatial sampled signal to a frequency representation of the same signal. By converting to a frequency representation, the DCT techniques have been shown to allow for very high levels of compression, as quantizers can be designed to take advantage of the frequency distribution characteristics of an image. In a preferred embodiment, one 16×16 DCT is applied to a first ordering, four 8×8 DCTs are applied to a second ordering, 16 4×4 DCTs are applied to a third ordering, and 64 2×2 DCTs are applied to a fourth ordering.

The DCT operation reduces the spatial redundancy inherent in the video source. After the DCT is performed, most of the video signal energy tends to be concentrated in a few DCT coefficients. An additional transform, the Differential Quad-Tree Transform (DQT), may be used to reduce the redundancy among the DCT coefficients.

For the 16×16 block and each sub-block, the DCT coefficient values and the DQT value (if the DQT is used) are analyzed to determine the number of bits required to encode the block or sub-block. Then, the block or the combination of sub-blocks that requires the least number of bits to encode is chosen to represent the image segment. For example, two 8×8 sub-blocks, six 4×4 sub-blocks, and eight 2×2 sub-blocks may be chosen to represent the image segment.

The chosen block or combination of sub-blocks is then properly arranged in order into a 16×16 block. The DCT/DQT coefficient values may then undergo frequency weighting, quantization, and coding (such as variable length coding) in preparation for transmission.

Although the ABSDCT technique described above performs remarkably well, it is computationally intensive.

Further, although use of the ABSDCT is visually lossless, it is sometimes desirable to recover data in the exact manner in which it was encoded. For example, mastering and archival purposes require to compress data in such a way as to be able to recover it exactly in its native domain.

Traditionally, a lossless compression system for images consists of a predictor, which estimates the value of the current pixel to be encoded. A residual pixel is obtained as the difference between the actual and the predicted pixel. The residual pixel is then entropy encoded and stored or transmitted. Since the prediction removes pixel correlation, the residual pixels have a reduced dynamic range with a characteristic two-sided exponential (Laplacian) distribution. Hence the compression. The amount of compression of the residuals depends on both the prediction and subsequent entropy encoding methods. Most commonly used prediction methods are differential pulse code modulation (DPCM) and its variants such as the adaptive DPCM (ADPCM).

A problem with lossless compression systems is that there is still a high variance, which results in high compression ratios. Therefore there is a need to optimize the compression ratios to improve the coding efficiency.

### SUMMARY OF THE INVENTION

Embodiments of the invention describe a system to encode digital image and video data in a lossless manner to achieve compression. The system is hybrid—meaning that it has a part that compresses the said data in a lossy manner and a part that compresses the residual data in a lossless fashion. For the lossy part, the system uses the adaptive block size discrete cosine transform (ABSDCT) algorithm. The ABSDCT system compresses the said data yielding a high visual quality and compression ratio. A residual image is obtained as the difference between the original and the decompressed one from the ABSDCT system. The residual is processed in the RGB color space, therefore improving coding efficiency. The residual may also be encoded losslessly using Golomb-Rice coding. Due to visually based adaptive block size and quantization of the DCT coefficients, the residuals have a very low energy and a lower variance, thus yielding good overall lossless compression ratios.

The ABSDCT system achieves a high compression ratio at cinema quality. Since it is block-based, it removes pixel correlation much better than any pel-based scheme. Therefore it is used as a predictor in the lossless system to be described here. In conjunction with this predictor a lossless encoding system is added to form a hybrid lossless compression system. It should be noted that the system is capable of compressing still images as well as motion images. If it is a still image, only the ABSDCT compressed data and entropy encoded residual data are used as the compressed output. For motion sequences, a decision is made whether to use intra-frame or inter-frame compression. For example, if f(t) represents an image frame at time instant t, F(t) and F(t+Δt) denote the DCTs of the image frames at time instants t and t+Δt, respectively. Note that Δt corresponds to the time interval between two consecutive frames.

The invention is embodied in an apparatus and method for compressing data that allows one to be able to recover the data in the exact manner in which the data was encoded. Embodiments comprise a system that performs intraframe coding, interframe coding, or a hybrid of the two. The system is a quality-based system that utilizes adaptively sized blocks and sub-blocks of Discrete Cosine Transform coefficient data. A block of pixel data is input to an encoder. The encoder comprises a block size assignment (BSA) element, which segments the input block of pixels for processing. The block size assignment is based on the variances of the input block and further subdivided blocks. In general, areas with larger variances are subdivided into smaller blocks, and areas with smaller variances are not be subdivided, provided the block and sub-block mean values fall into different predetermined ranges. Thus, first the variance threshold of a block is modified from its nominal value depending on its mean value, and then the variance of the block is compared with this threshold, and if the variance is greater than the threshold, then the block is subdivided.

The block size assignment is provided to a transform element, which transforms the pixel data into frequency domain data. The transform is performed only on the block and sub-blocks selected through block size assignment. For AC elements, the transform data then undergoes scaling through quantization and serialization. Quantization of the transform data is quantized based on an image quality metric, such as a scale factor that adjusts with respect to contrast, coefficient count, rate distortion, density of the block size assignments, and/or past scale factors. Serialization, such as zigzag scanning, is based on creating the longest possible run lengths of the same value. The stream of data is then coded by a variable length coder in preparation for transmission. Coding may be Huffman coding, or coding may be based on an exponential distribution, such as Golomb-Rice encoding.

The use of a hybrid compression system such as the ABSDCT, acts like a good predictor of pixel or DCT values. Therefore it results in a higher lossless compression ratio than the systems using pel-based prediction. The lossy portion provides digital cinema quality results—that is, the compression results in a file that is visually lossless. For the lossless portion, conversion of the pixels from one color component space to another color component space increases compression ratios. That is, conversion of pixels from the YC_{B}C_{R} space into the RGB color space lowers overall variance. Further, representing the image(s) as a difference of RGB color components further increases compression ratios. For example, the R, B-G, R-G space may be utilized, resulting in lower variance and thus a higher degree of compression. This results in a more efficient use of the chip real estate. Hence, the chip size is reduced in hardware implementation. Further, the Golomb-Rice encoding is much simpler to implement than Huffman coding. Also, Golomb-Rice coding achieves a higher coding efficiency than the Huffman coding as the DCT coefficients or residuals have an exponential distribution naturally. Further, as the lossy portion of the compression system uses visually significant information in the block sub-division, context modeling is inherent in the residual encoding. This is important in that no extra storage registers are needed in gathering contextual data for the residual encoding. Since no motion estimation is used, the system is very simple to implement also.

An apparatus and method for losslessly compressing and encoding signals representing image information is claimed. Signals representing image information are compressed to create a compressed version of the image in a first color component space. The compressed version of the image is quantized, thereby creating a lossy version of the image. The compressed version of the image is also serialized to create a serialized quantized compressed version of the image. This version is then decompressed, and the differences between the original image and the decompressed version are determined, thereby creating a residual version of the image in the first color component space. The residual version of the image is then converted from the first color component space to a second color component space. The lossy version of the image and the residual version of the image may be output separately or combined, wherein the combination of the decompressed lossy version of the image and the residual version of the image is substantially the same as the original image.

A method of losslessly compressing and encoding signals representing image information is claimed. A lossy compressed data file and a residual compressed data file are generated. When the lossy compressed data file and the residual compressed data file are combined, a lossless data file that is substantially identical to the original data file is created.

Accordingly, it is an aspect of an embodiment to provide an apparatus and method to efficiently provide lossless compression.

It is another aspect of an embodiment that compresses digital image and audio information losslessly in a manner conducive to mastering and archival purposes.

It is another aspect of an embodiment to provide a lossless compression system on an interframe basis.

It is another aspect of an embodiment to provide a lossless compression system on an intraframe basis.

It is another aspect of an embodiment to provide a lossless compression system having minimized the entropy.

It is another aspect of an embodiment to provide a lossless compression system utilizing a derivation of the RGB color space.

It is another aspect of an embodiment to utilize the R, R-B, R-G color space in lossless encoding.

### BRIEF DESCRIPTION OF THE DRAWINGS

The features and advantages of the present invention will become more apparent from the detailed description set forth below when taken in conjunction with the drawings in which like reference characters identify correspondingly throughout and wherein:

FIG. 1 is a block diagram of an encoder portion of an image compression and processing system;

FIG. 2 is a block diagram of a decoder portion of an image compression and processing system;

FIG. 3 illustrates a process of encoding DC component values;

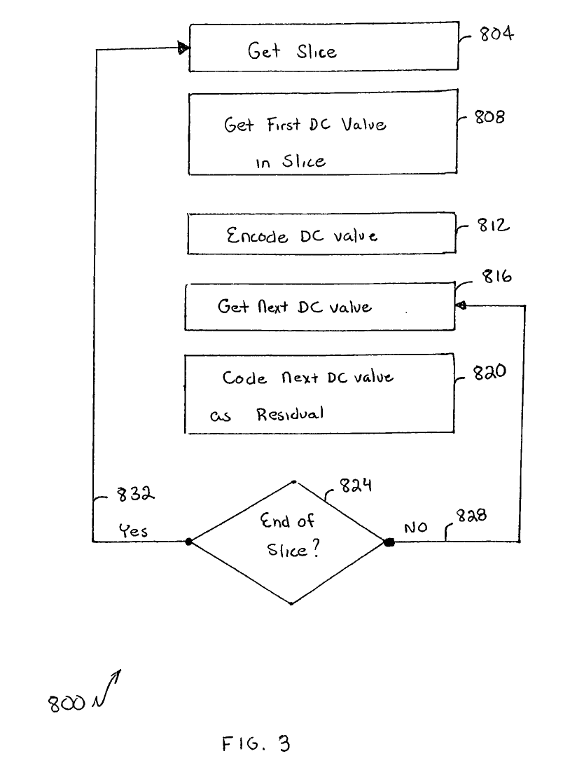

FIG. 4 illustrates an apparatus for lossless compression; and

FIG. 5 illustrates a method of hybrid lossless compression.

### DETAILED DESCRIPTION OF THE PREFERRED EMBODIMENTS

In order to facilitate digital transmission of digital signals and enjoy the corresponding benefits, it is generally necessary to employ some form of signal compression. While achieving high compression in a resulting image, it is also important that high quality of the image be maintained. Furthermore, computational efficiency is desired for compact hardware implementation, which is important in many applications.

Before one embodiment of the invention is explained in detail, it is to be understood that the invention is not limited in its application to the details of the construction and the arrangement of the components set forth in the following description or illustrated in the drawings. The invention is capable of other embodiments and are carried out in various ways. Also, it is understood that the phraseology and terminology used herein is for purpose of description and should not be regarded as limiting.

Lossless image compression employed in an aspect of an embodiment is based on discrete cosine transform (DCT) techniques, such as that disclosed in co-pending U.S. patent application “An Apparatus And Method For Encoding Digital Image Data In A Lossless Manner”, filed on Jun. 26, 2002, assigned to the assignee of the present application and incorporated herein by reference.

Contrast adaptive methods utilize intraframe coding (spatial processing) instead of interframe coding (spatio-temporal processing). Interframe coding inherently requires multiple frame buffers in addition to more complex processing circuits. In many applications, reduced complexity is needed for actual implementation. Intraframe coding is also useful in a situation that can make a spatio-temporal coding scheme break down and perform poorly. For example, 24 frame per second movies can fall into this category since the integration time, due to the mechanical shutter, is relatively short. The short integration time allows a higher degree of temporal aliasing. The assumption of frame-to-frame correlation breaks down for rapid motion as it becomes jerky. Intraframe coding is also easier to standardize when both 50 Hz and 60 Hz power line frequencies are involved. Television currently transmits signals at either 50 Hz or 60 Hz. The use of an intraframe scheme, being a digital approach, can adapt to both 50 Hz and 60 Hz operation, or even to 24 frame per second movies by trading off frame rate versus spatial resolution.

For image processing purposes, the DCT operation is performed on pixel data that is divided into an array of non-overlapping blocks. Note that although block sizes are discussed herein as being N×N in size, it is envisioned that various block sizes may be used. For example, a N×M block size may be utilized where both N and M are integers with M being either greater than or less than N. Another important aspect is that the block is divisible into at least one level of sub-blocks, such as N/i×N/i, N/i×N/j, N/i×M/j, and etc. where i and j are integers. Furthermore, the exemplary block size as discussed herein is a 16×16 pixel block with corresponding block and sub-blocks of DCT coefficients. It is further envisioned that various other integers such as both even or odd integer values may be used, e.g. 9×9.

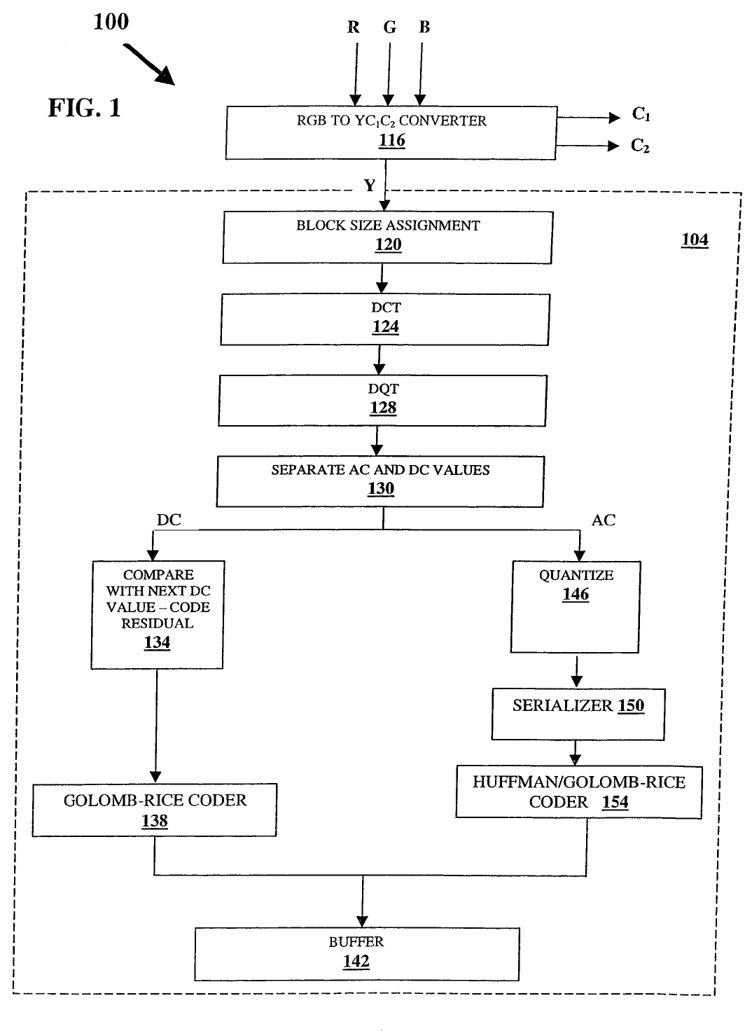

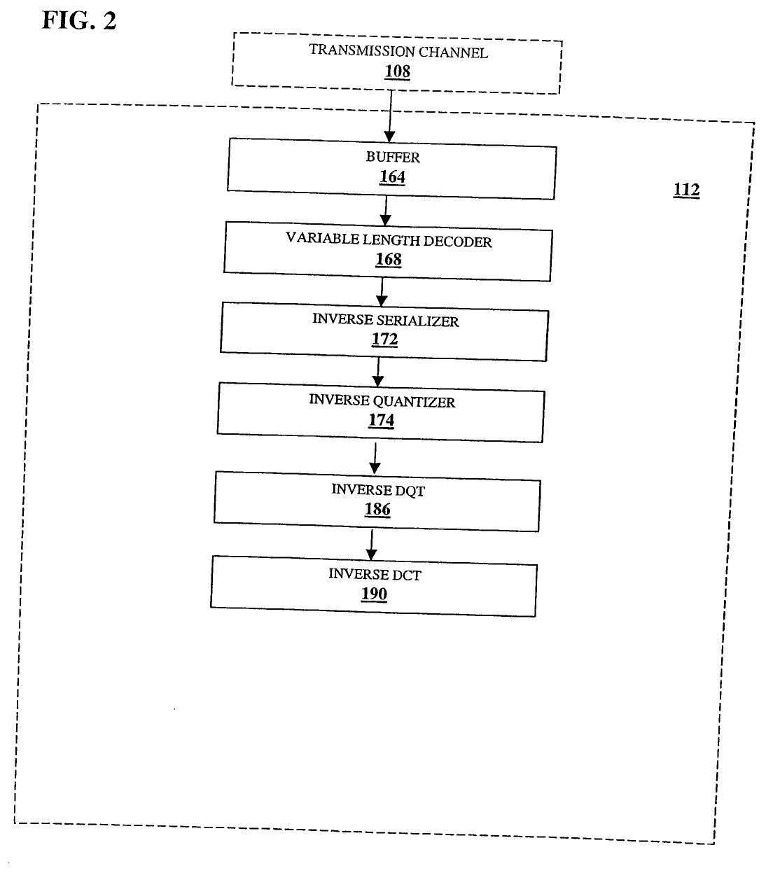

FIGS. 1 and 2 illustrate an image processing system 100 incorporating the concept of configurable serializer. The image processing system 100 comprises an encoder 104 that compresses a received video signal. The compressed signal is transmitted using a transmission channel or a physical medium 108, and received by a decoder 112. The decoder 112 decodes the received encoded data into image samples, which may then be exhibited.

In general, an image is divided into blocks of pixels for processing. A color signal may be converted from RGB space to YC₁C₂ space using a RGB to YC₁C₂ converter 116, where Y is the luminance, or brightness, component, and C₁ and C₂ are the chrominance, or color, components. Because of the low spatial sensitivity of the eye to color, many systems sub-sample the C₁ and C₂ components by a factor of four in the horizontal and vertical directions. However, the sub-sampling is not necessary. A full resolution image, known as 4:4:4 format, may be either very useful or necessary in some applications such as those referred to as covering “digital cinema.” Two possible YC₁C₂ representations are, the YIQ representation and the YUV representation, both of which are well known in the art. It is also possible to employ a variation of the YUV representation known as YCbCr. This may be further broken into odd and even components. Accordingly, in an embodiment the representation Y-even, Y-odd, Cb-even, Cb-odd, Cr-even, Cr-odd is used.

In a preferred embodiment, each of the even and odd Y, Cb, and Cr components is processed without sub-sampling. Thus, an input of each of the six components of a 16×16 block of pixels is provided to the encoder 104. For illustration purposes, the encoder 104 for the Y-even component is illustrated. Similar encoders are used for the Y-odd component, and even and odd Cb and Cr components. The encoder 104 comprises a block size assignment element 120, which performs block size assignment in preparation for video compression. The block size assignment element 120 determines the block decomposition of the 16×16 block based on the perceptual characteristics of the image in the block. Block size assignment subdivides each 16×16 block into smaller blocks, such as 8×8, 4×4, and 2×2, in a quad-tree fashion depending on the activity within a 16×16 block. The block size assignment element 120 generates a quad-tree data, called the PQR data, whose length can be between 1 and 21 bits. Thus, if block size assignment determines that a 16×16 block is to be divided, the R bit of the PQR data is set and is followed by four additional bits of Q data corresponding to the four divided 8×8 blocks. If block size assignment determines that any of the 8×8 blocks is to be subdivided, then four additional bits of P data for each 8×8 block subdivided are added.

Note that a similar procedure is used to assign block sizes for the luminance component Y-odd and the color components, C_{b} and Cᵣ. The color components may be decimated horizontally, vertically, or both.

Additionally, note that although block size assignment has been described as a top down approach, in which the largest block (16×16 in the present example) is evaluated first, a bottom up approach may instead be used. The bottom up approach will evaluate the smallest blocks (2×2 in the present example) first.

Referring back to FIG. 1, the PQR data, along with the addresses of the selected blocks, are provided to a DCT element 124. The DCT element 124 uses the PQR data to perform discrete cosine transforms of the appropriate sizes on the selected blocks. Only the selected blocks need to undergo DCT processing.

The image processing system 100 also comprises DQT element 128 for reducing the redundancy among the DC coefficients of the DCTs. A DC coefficient is encountered at the top left corner of each DCT block. The DC coefficients are, in general, large compared to the AC coefficients. The discrepancy in sizes makes it difficult to design an efficient variable length coder. Accordingly, it is advantageous to reduce the redundancy among the DC coefficients.

The DQT element 128 performs 2-D DCTs on the DC coefficients, taken 2×2 at a time. Starting with 2×2 blocks within 4×4 blocks, a 2-D DCT is performed on the four DC coefficients. This 2×2 DCT is called the differential quad-tree transform, or DQT, of the four DC coefficients. Next, the DC coefficient of the DQT along with the three neighboring DC coefficients within an 8×8 block are used to compute the next level DQT. Finally, the DC coefficients of the four 8×8 blocks within a 16×16 block are used to compute the DQT. Thus, in a 16×16 block, there is one true DC coefficient and the rest are AC coefficients corresponding to the DCT and DQT.

The transform coefficients (both DCT and DQT) are provided to a quantizer for quantization. In a preferred embodiment, the DCT coefficients are quantized using frequency weighting masks (FWMs) and a quantization scale factor. A FWM is a table of frequency weights of the same dimensions as the block of input DCT coefficients. The frequency weights apply different weights to the different DCT coefficients. The weights are designed to emphasize the input samples having frequency content that the human visual or optical system is more sensitive to, and to de-emphasize samples having frequency content that the visual or optical system is less sensitive to. The weights may also be designed based on factors such as viewing distances, etc.

AC values are then separated 130 from DC values and processed separately. For DC elements, a first DC component value of each slice is encoded. Each subsequent DC component value of each slice is then represented as the difference between it and the DC component value preceding it, and encoded 134. For lossless encoding, the initial DC component value of each slice and the differences are encoded 138 using Golomb-Rice, as described with respect to FIG. 6. Use of Golomb-Rice encoding for the differences between successive DC component values is advantageous in that the differentials of the DC component values tend to have a two-sided exponential distribution. The data may then be temporarily stored using a buffer 142, and then transferred or transmitted to the decoder 112 through the transmission channel 108.

For AC elements, the block of data and frequency weighting masks are then scaled by a quantizer 146, or a scale factor element. Quantization of the DCT coefficients reduces a large number of them to zero which results in compression. In a preferred embodiment, there are 32 scale factors corresponding to average bit rates. Unlike other compression methods such as MPEG2, the average bit rate is controlled based on the quality of the processed image, instead of target bit rate and buffer status.

To increase compression further, the quantized coefficients are provided to a scan serializer 150. The serializer 150 scans the blocks of quantized coefficients to produce a serialized stream of quantized coefficients. Zigzag scans, column scanning, or row scanning may be employed. A number of different zigzag scanning patterns, as well as patterns other than zigzag may also be chosen. A preferred technique employs 8×8 block sizes for the zigzag scanning. A zigzag scanning of the quantized coefficients improves the chances of encountering a large run of zero values. This zero run inherently has a decreasing probability, and may be efficiently encoded using Huffman codes.

The stream of serialized, quantized AC coefficients is provided to a variable length coder 154. The AC component values may be encoded either using Huffman encoding or Golomb-Rice encoding. For DC component values, Golomb-Rice encoding is utilized. A run-length coder separates the coefficients between the zero from the non-zero coefficients. In an embodiment, Golomb-Rice coding is utilized. Golomb-Rice encoding is efficient in coding non-negative integers with an exponential distribution. Using Golomb codes is more optimal for compression in providing shorter length codes for exponentially distributed variables.

Residual pixels maybe generated by first decompressing the compressed data using the ABSDCT decoder, and then subtracting it from the original data. Smaller the residual dynamic range, higher is the compression. Since the compression is block-based, the residuals are also generated on a block basis. It is a well-known fact that the residual pixels have a two-sided exponential distribution, usually centered at zero. Since Golomb-Rice codes are more optimal for such data, a Golomb-Rice coding procedure is used to compress the residual data. However, no special codes are necessary, as there are no run-lengths to be encoded. Further, there is no need for an EOB code. Thus, the compressed data consists of two components. One is the component from the lossy compressor and the other is from the lossless compressor.

When encoding motion sequences one can benefit from exploiting the temporal correlation as well. In order to exploit fully the temporal correlation, pixel displacement is first estimated due to motion, and then a motion compensated prediction is performed to obtain residual pixels. As ABSDCT performs adaptive block size encoding, block size information may be alternatively used as a measure of displacement due to motion. As a further simplification, no scene change detection is used. Instead, for each frame in a sequence first the intra-frame compressed data is obtained. Then the difference between the current and previous frame DCTs, are generated on a block-by-block basis. This is described further by U.S. patent application Ser. No. 09/877,578, filed Jun. 7, 2001, which is incorporated by reference herein. These residuals in the DCT domain are encoded using both Huffman and Golomb-Rice coding procedures. The final compressed output then corresponds to the one that uses the minimum number of bits per frame.

The lossless compression algorithm is a hybrid scheme that lends itself well to repurposing and transcoding by stripping off the lossless portion. Thus, using ABSDCT maximizes pixel correlation in the spatial domain resulting in residual pixels having a lower variance than those used in prediction schemes. The lossy portion of the overall system permits the user to achieve the necessary quality and data rates for distribution purposes without having to resort to interframe processing, thereby eliminating related motion artifacts and significantly reducing implementation complexities. This is especially significant in programs being distributed for digital cinema applications, since the lossy portion of the compressed material requires a higher level of quality in its distribution.

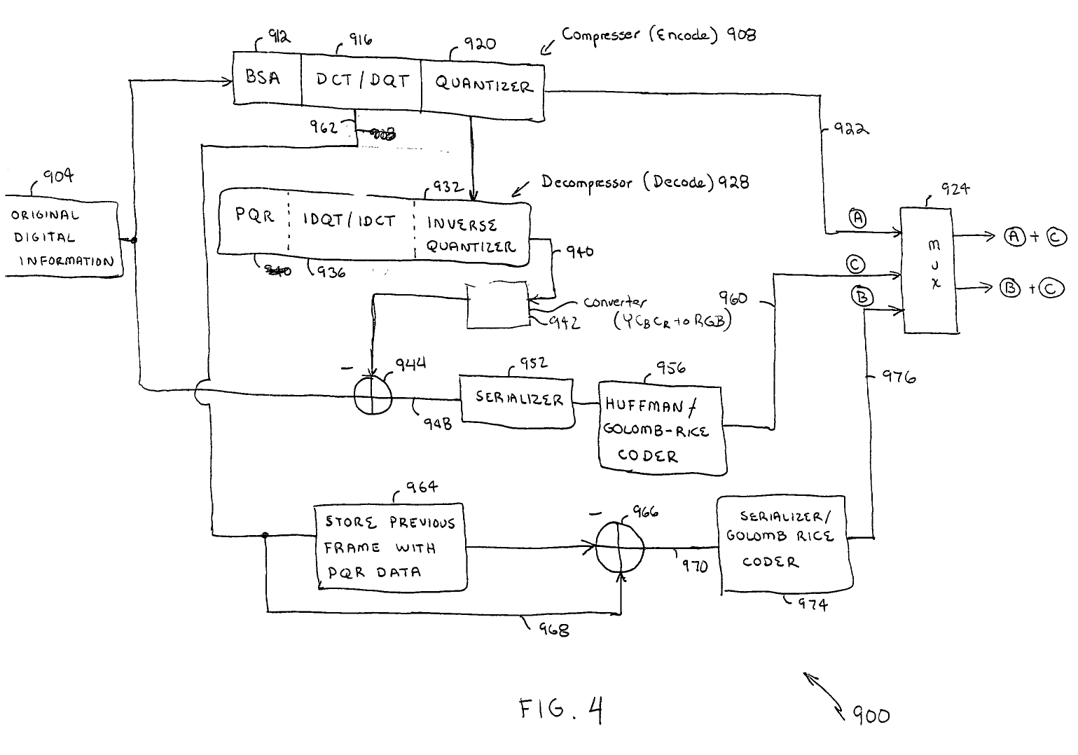

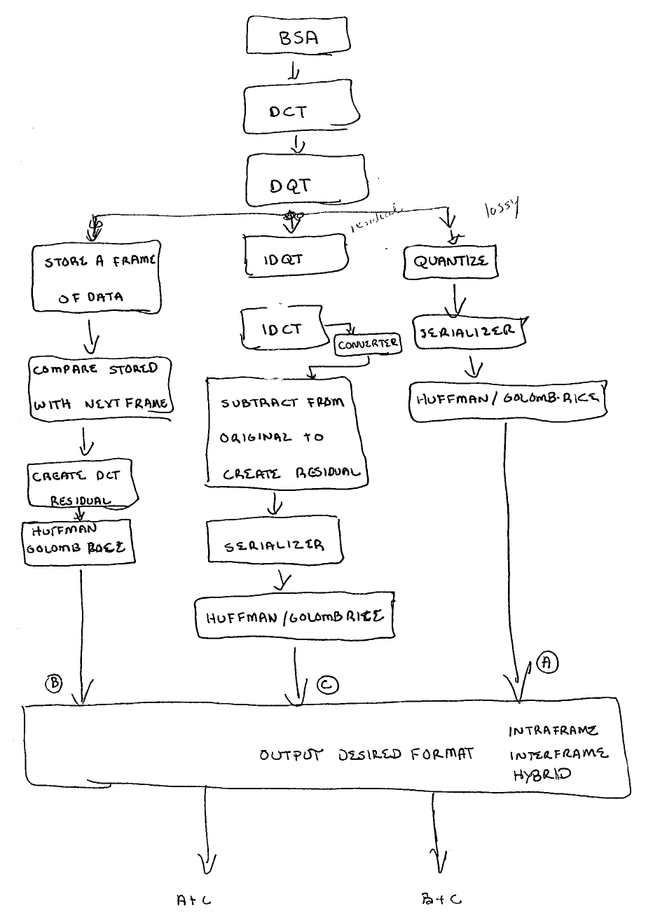

FIG. 4 illustrates a hybrid lossless encoding apparatus 900. FIG. 5 illustrates a process that may be run on such an apparatus. Original digital information 904 resides on a storage device, or is transmitted. Many of the elements in FIG. 5 are described in more detail with respect to FIGS. 1 and 2. Frames of data are sent to a compressor 908, comprising a block size assignment element 912, a DCT/DQT transform element 916, and a quantizer 920. After the DCT/DQT is performed on the data, the data is converted into the frequency domain. In one output 922, the data is quantized by the quantizer 920 and transferred to an output 924, which may comprises storage and/or switching. All of the above described processing is on an intraframe basis.

The quantizer output is also transferred to a decompressor 928. The decompressor 928 undoes the process of the compressor, going through an inverse quantizer 932, and an IDQT/IDCT 936, along with knowledge of the PQR data as defined by the BSA. The result of the decompressor 940 is fed to a color space convertor 942, and then to subtractor 944 where it is compared with the original. Color space converter 942 converts the data into the RGB (red, green, blue) color space from the YC_{bCr} space. As such, the hybrid system may use lossy compression in the YC_{bCr} and a lossless coding of the residual pixels in the RGB space, or more particularly, the R, B-G, R-G space. In doing so, several advantages are realized. One, G is similar to the luminous component Y. Two, the B-G and R-G color components tend to have a lower variance than YC_{bCr}, with skewed probability densities. Hence, the lossy compression ratios are much higher than obtained in the RGB space. Therefore the compression ratio for the residual portion in the G, B-G, R-G space is also higher. Thus, the overall lossless compression ratio is higher in the G, B-G, R-G space than in the RGB space. Also, the RGB components are preserved in that they may be recovered, mathematically lossless, from the G, B-G, R-G space since the coefficients of the transformation are unity.

Subtractor 944 may be a variety of elements, such as a differencer, that computes residual pixels as the difference between the uncompressed and the compressed and decompressed pixels for each block. Additionally, the differencer may obtain the residuals in the DCT domain for each block for conditional interframe coding. The result 948 of the comparison between the decompressed data and the original is the pixel residual file. That is, the result 948 is indicative of the losses experienced by the data being compressed and uncompressed. Thus, the original data is equal to the output 922 in combination with the result 948. The result 948 is then serialized 952 and Huffman and/or Golomb Rice encoder 956, and provided as a second output 960. The Huffman and/or Golomb Rice encoder 956 may be a type of entropy encoder that encodes residuals pixels using Golomb Rice coding. A decision is made whether to use intraframe or interframe based on the minimum bits for each frame. Use of Golomb Rice coding of the residuals leads to higher overall compression ratios of the system.

Thus, the lossless, interframe output is a combination, or hybrid of two sets of data, the lossy, high quality image file (922, or A) and the residual file (960 or C).

Interframe coding may also be utilized. The output of the quantizer is transferred to a store 964, along with knowledge of the BSA. Upon gathering of a frame's worth of data, a subtractor 966 compares the stored frame 964 with a next frame 968. The difference results in a DCT residual 970, which is then serialized and/or Golomb-Rice encoded 974, providing a third output data set 976 to the output 924. Thus, an interframe lossless file of B and C is compiled. Thus, either combination (A+C or B+C) may be chosen based on size considerations. Further, a purely intraframe output may be desirable for editing purposes.

Referring back to FIG. 1, the compressed image signal generated by the encoder 104 may be temporarily stored using a buffer 142, and then transmitted to the decoder 112 using the transmission channel 108. The transmission channel 108 may be a physical medium, such as a magnetic or optical storage device, or a wire-line or wireless conveyance process or apparatus. The PQR data, which contains the block size assignment information, is also provided to the decoder 112 (FIG. 2). The decoder 112 comprises a buffer 164 and a variable length decoder 168, which decodes the run-length values and the non-zero values. The variable length decoder 168 operates in a similar but opposite manner as that described above.

The output of the variable length decoder 168 is provided to an inverse serializer 172 that orders the coefficients according to the scan scheme employed. For example, if a mixture of zigzag scanning, vertical scanning, and horizontal scanning were used, the inverse serializer 172 would appropriately re-order the coefficients with the knowledge of the type of scanning employed. The inverse serializer 172 receives the PQR data to assist in proper ordering of the coefficients into a composite coefficient block.

The composite block is provided to an inverse quantizer 174, for undoing the processing due to the use of the quantizer scale factor and the frequency weighting masks.

The coefficient block is then provided to an IDQT element 186, followed by an IDCT element 190, if the Differential Quad-tree transform had been applied. Otherwise, the coefficient block is provided directly to the IDCT element 190. The IDQT element 186 and the IDCT element 190 inverse transform the coefficients to produce a block of pixel data. The pixel data may then have to be interpolated, converted to RGB form, and then stored for future display.

As examples, the various illustrative logical blocks, flowcharts, and steps described in connection with the embodiments disclosed herein may be implemented or performed in hardware or software with an application-specific integrated circuit (ASIC), a programmable logic device, discrete gate or transistor logic, discrete hardware components, such as, e.g., registers and FIFO, a processor executing a set of firmware instructions, any conventional programmable software and a processor, or any combination thereof. The processor may advantageously be a microprocessor, but in the alternative, the processor may be any conventional processor, controller, microcontroller, or state machine. The software could reside in RAM memory, flash memory, ROM memory, registers, hard disk, a removable disk, a CD-ROM, a DVD-ROM or any other form of storage medium known in the art.

The previous description of the preferred embodiments is provided to enable any person skilled in the art to make or use the present invention. The various modifications to these embodiments will be readily apparent to those skilled in the art, and the generic principles defined herein may be applied to other embodiments without the use of the inventive faculty. Thus, the present invention is not intended to be limited to the embodiments shown herein but is to be accorded the widest scope consistent with the principles and novel features disclosed herein.

Other features and advantages of the invention are set forth in the following claims.

1. A method of losslessly compressing and encoding signals representing an image, the method comprising:
generating a lossy compressed data file in a first color component space;
generating a residual compressed data file in a second color component space; and
combining the lossy data file with the residual data file to create a lossless data file, wherein the lossless data file is substantially identical to the original data file.

2. The method as set forth in claim 1, wherein the lossy compressed data file and the residual compressed data file are generated on an intraframe basis.

3. The method as set forth in claim 1, wherein the lossy compressed data file and the residual compressed data file are generated on an interframe basis.

4. The method set forth in claim 1, wherein generating utilizes a combination of discrete cosine transform (DCT) and discrete quadtree transform (DQT) techniques.

5. The method set forth in claim 1, wherein generating utilizes Golomb-Rice coding techniques.

6. The method set forth in claim 1, wherein the first color component space is based on the YC_{B}C_{R} color space and the second color component space is based on the RGB color space.

7. The method set forth in claim 6, wherein the second color component space is the R, B-G, R-G color component space.

8. An apparatus to losslessly compress and encode signals representing an image, the apparatus comprising:
means for generating a lossy compressed data file in a first color component space;
means for generating a residual compressed data file in a second color component space; and
means for combining the lossy data file with the residual data file to create a lossless data file, wherein the lossless data file is substantially identical to the original data file.

9. The apparatus as set forth in claim 8, wherein the means for generating the lossy compressed data file and the means for generating the residual compressed data file are generated on an intraframe basis.

10. The apparatus as set forth in claim 8, wherein the means for generating the lossy compressed data file and the means for generating the residual compressed data file are generated on an interframe basis.

11. The apparatus set forth in claim 8, wherein the means for generating utilizes a combination of discrete cosine transform (DCT) and discrete quadtree transform (DQT) techniques.

12. The apparatus set forth in claim 8, wherein the means for generating utilizes Golomb-Rice coding techniques.

13. The apparatus set forth in claim 8, wherein the first color component space is based on the YC_{B}C_{R} color space and the second color component space is based on the RGB color space.

14. The apparatus set forth in claim 13, wherein the second color component space is the R, B-G, R-G color component space.

15. A method for losslessly compressing and encoding signals representing an image, the method comprising:
compressing the signals representing the image thereby creating a compressed version of the image in a first color component space;
quantizing the compressed version of the image thereby creating a lossy version of the image;
serializing the quantized compressed version of the image thereby creating a serialized quantized compressed version of the image;
decompressing the compressed version of the image;
determining the differences between the image and the decompressed version of the image thereby creating a residual version of the image in the first color component space;
converting the residual version of the image from the first color component space to a second color component space; and
outputting the lossy version of the image and the residual version of the image, wherein the combination of the lossy version of the image and the residual version of the image is substantially the same as the original image.

16. The method set forth in claim 15, wherein the lossless compression is on an intraframe basis.

17. The method set forth in claim 15, wherein compressing utilizes a combination of discrete cosine transform (DCT) and discrete quadtree transform (DQT) techniques.

18. The method set forth in claim 15, wherein serializing utilizes Golomb-Rice coding techniques.

19. The method set forth in claim 15, wherein the first color component space is based on the YC_{B}C_{R} color space and the second color component space is based on the RGB color space.

20. The method set forth in claim 19, wherein the second color component space is the R, B-G, R-G color component space.

21. A method for losslessly compressing and encoding signals representing image information, the image comprising a plurality of frames, the method comprising:
compressing a first frame thereby creating a compressed version of the image;
quantizing the compressed version of the image thereby creating a lossy version of the image;
serializing the quantized compressed version of the image thereby creating a serialized quantized compressed version of the image;
compressing a second frame of signals representing the image;
determining the differences between the first frame and the second frame of the image thereby creating a residual version of the image in the first color component space;
converting the residual version of the image from the first color component space to a second color component space; and
outputting the lossy version of the image with the residual version of the image, wherein the combination of the lossy version of the image and the residual version of the image is substantially the same as the original image.

22. The method set forth in claim 21, wherein the lossless compression is on an interframe basis.

23. The method set forth in claim 21, wherein compressing utilizes a combination of discrete cosine transform (DCT) and discrete quadtree transform (DQT) techniques.

24. The method set forth in claim 21, wherein serializing utilizes Golomb-Rice coding techniques.

25. The method set forth in claim 21, wherein the first color component space is based on the YC_{B}C_{R} color space and the second color component space is based on the RGB color space.

26. The method set forth in claim 25, wherein the second color component space is the R, B-G, R-G color component space.

27. An apparatus for losslessly compressing and encoding signals representing an image, the method comprising:
means for compressing the signals representing the image thereby creating a compressed version of the image in a first color component space;
means for quantizing the compressed version of the image thereby creating a lossy version of the image;
means for serializing the quantized compressed version of the image thereby creating a serialized quantized compressed version of the image;
means for decompressing the compressed version of the image;
means for determining the differences between the image and the decompressed version of the image thereby creating a residual version of the image in the first color component space;
means for converting the residual version of the image from the first color component space to a second color component space; and
means for outputting the lossy version of the image and the residual version of the image, wherein the combination of the lossy version of the image and the residual version of the image is substantially the same as the original image.

28. The apparatus set forth in claim 27, wherein the lossless compression is on an intraframe basis.

29. The apparatus set forth in claim 27, wherein the means for compressing utilizes a combination of discrete cosine transform (DCT) and discrete quadtree transform (DQT) techniques.

30. The apparatus set forth in claim 27, wherein the first color component space is based on the YC_{B}C_{R} color space and the second color component space is based on the RGB color space.

31. The apparatus set forth in claim 30, wherein the second color component space is the R, B-G, R-G color component space.

32. An apparatus for losslessly compressing and encoding signals representing image information, the image comprising a plurality of frames, the method comprising:
means for compressing a first frame thereby creating a compressed version of the image in a first color component space;
means for quantizing the compressed version of the image thereby creating a lossy version of the image;
means for serializing the quantized compressed version of the image thereby creating a serialized quantized compressed version of the image;
means for compressing a second frame of signals representing the image;
means for determining the differences between the first frame and the second frame of the image thereby creating a residual version of the image in the first color component space;
means for converting the residual version of the image from the first color component space to a second color component space; and
means for outputting the lossy version of the image with the residual version of the image, wherein the combination of the lossy version of the image and the residual version of the image is substantially the same as the original image.

33. The apparatus set forth in claim 32, wherein the lossless compression is on an interframe basis.

34. The apparatus set forth in claim 32, wherein the means for compressing utilizes a combination of discrete cosine transform (DCT) and discrete quadtree transform (DQT) techniques.

35. The apparatus set forth in claim 32, wherein the first color component space is based on the YC_{B}C_{R} color space and the second color component space is based on the RGB color space.

36. The apparatus set forth in claim 33, wherein the second color component space is the R, B-G, R-G color component space.

37. An apparatus for losslessly compressing and encoding signals representing an image, the method comprising:
a compressor element configured to perform discrete cosine transforms (DCTs) and discrete quadtree transforms (DQTs) to the signals representing the image thereby creating a compressed version of the image in a first color component space;
a quantizer element coupled to the compressor element configured to quantize the compressed version of the image thereby creating a lossy version of the image;
a serializer element coupled to the quantizer element configured to serialize the quantized compressed version of the image thereby creating a serialized quantized compressed version of the image;
a decompressor element configured to perform inverse DCTs (IDCTs) and inverse DQTs (IDQTs) the compressed version of the image;
a determiner element configured to determine the differences between the image and the decompressed version of the image thereby creating a residual version of the image in the first color component space;
a converter to configured to convert the residual version of the image from the first color component space to a second color component space; and
a combiner element configured to combine the lossy version of the image and the residual version of the image, wherein the combination of the lossy version of the image and the residual version of the image is substantially the same as the original image.

38. The apparatus set forth in claim 37, wherein the first color component space is based on the YC_{B}C_{R} color space and the second color component space is based on the RGB color space.

39. The apparatus set forth in claim 38, wherein the second color component space is the R, B-G, R-G color component space.
